(19) United States
(12) Patent Application Publication
(10) Pub. No.: US 2021/0370350 A1
(43) Pub. Date: Dec. 2, 2021

(54) Apparatus and Method for Processing Plant Material

(71) Applicant: Alto Technologies, Inc., Grass Valley, CA (US)

(72) Inventors: Summer ORMAN, Chicago Park, CA (US); Joshua ORMAN, Chicago Park, CA (US); Robert WINIECKI, Placerville, CA (US)

(73) Assignee: Alto Technologies, Inc., Grass Valley, CA (US)

(21) Appl. No.: 16/884,803

(22) Filed: May 27, 2020

(51) Int. Cl. B07B 1/22; B07B 1/42

(52) U.S. Cl. CPC B07B 1/22; B07B 2201/04; B07B 1/42

(57) ABSTRACT

A device and method for separating solid material with thorough gentle precision processing in order to maintain the integrity of the desired portion of the solid material, employs a separating apparatus including two or more vertically spaced barrels, each of which rotates within a respective saddle. After solid material is introduced into one of the barrels, the barrel is rotated, and the solid material is rotationally tumbled and axially propagated through the barrel. As the solid material moves through the barrel, portions of the solid material are separated therefrom by various means including collision, vibration, grating or cutting.

### FIELD OF THE INVENTION

The present invention pertains to devices and methods for processing solid material. More particularly, the present invention relates to devices and methods for separating solid material.

### BACKGROUND OF THE INVENTION

In various industries, solid raw material is processed into finished goods. In some cases, processing the solid material includes separating and/or sorting the solid material. There is a continuing need in the art for machine systems and methods that efficiently separate and/or sort solid material.

### SUMMARY OF THE INVENTION

In accordance with the present invention, solid material (e.g., agricultural material, particularly agricultural plant material) undergoes precision processing using a separation apparatus including two or more vertically spaced barrels, each rotating within a respective saddle. After solid material is introduced into one of the barrels, the barrel is rotated, and the material is rotationally tumbled and axially propagated through the barrel. As the material moves through the barrel, portions of the material are separated by various means, such as collision, vibration, grating or cutting. The gentle precision processing provided by the present invention maintains the integrity of the desired portion of the material.

In one embodiment, solid material is processed in a first barrel and then transferred to and further processed in a second barrel that is vertically spaced from the first barrel. The solid material can be transferred between the barrels by any suitable means. However, transfer of the solid material by gravity using a transfer unit such as a hopper is preferable. In another embodiment, solid material is processed simultaneously in two or more vertically spaced barrels.

Each barrel has a plurality of spaced openings disposed in its surface through which portions of the solid material can protrude and interact with the barrel's respective saddle as the solid material is rotationally tumbled through the barrel. Each saddle also has a plurality of spaced openings disposed in its surface. The openings in the barrel and the openings in the saddle overlap at a multitude of positions during rotation of the barrel within the saddle. Preferably, the saddles are fixed relative to the barrels and act as fixed cutting or trimming blades. The saddles may include one or more sections that wrap at least partially around their respective barrels. In particular embodiments, the saddles are removable to facilitate cleaning. Portions of the solid material that are separated therefrom (e.g., trimmings) can fall through the openings in the barrels and saddles and into a collection bin placed below the barrels. Alternately, or in addition to the collection bin, the separated portions of the solid material can be collected with the assistance of a vacuum system. The vacuum system may also assist in causing the portions of the solid material to protrude through the openings in a barrel to interact with the barrel's respective saddle.

In particular embodiments, each barrel gently rotates by means of a motor, preferably an energy efficient motor such as a DC brushless gear motor, or by a pneumatic or hydraulic motor. Also, in particular embodiments, a longitudinal tilt mechanism can be employed to selectively lift or lower an end of a barrel so as to control the speed at which the solid material is processed through the barrel. Preferably, the longitudinal tilt mechanism includes a linear actuator.

In preferred embodiments, the solid material is processed using an airflow which in some cases may be temperature- and/or humidity-controlled.

The system and method of the present invention can be combined with other processing techniques such as desiccation/curing/drying, sterilization and sorting/grading. After solid material is processed using the system or method of the present invention, the processed solid material is inspected, preferably using machine learning technology, to determine if the product is ready for the next process step (e.g., packaging).

Additional objects, features and advantages of the invention will become more readily apparent from the following detailed description of the invention when taken in conjunction with the drawings wherein like reference numerals refer to common parts in the several views.

### BRIEF DESCRIPTION OF THE DRAWINGS

FIG. 1 is a front view of an embodiment of a separating apparatus constructed in accordance with the present invention;

FIG. 2 is a rear view of the apparatus shown in FIG. 1;

FIG. 3 is a perspective rear view of the apparatus shown in FIG. 1;

FIG. 4 is another perspective rear view of the apparatus shown in FIG. 1;

FIG. 5 is a perspective view of an embodiment of a rotatable barrel for a separating apparatus in accordance with the present invention;

FIG. 6 is a perspective view of an embodiment of a saddle for a separating apparatus in accordance with the present invention;

FIG. 7 is a perspective view of another embodiment of a separating apparatus for processing solid material in accordance with the invention in which the transfer of solid material between two rotatable barrels is facilitated by a transfer unit;

FIG. 8 is a front view of another embodiment of a separating apparatus for processing solid material in accordance with the invention in which collection of separated portions of the solid material is facilitated by a vacuum system;

FIG. 9 is a rear view of the apparatus shown in FIG. 8;

FIG. 10 is an overview of a solid material processing system including a separating apparatus in accordance with the present invention;

FIG. 11 is a flow chart illustrating Phase One of a method for processing solid material;

FIG. 12 is a flow chart illustrating Phase Two of a method for processing solid material;

FIG. 13 is a flow chart illustrating Phase Three of a method for processing solid material; and

FIG. 14 is a flow chart illustrating Phase Four of a method for processing solid material.

### DETAILED DESCRIPTION OF INVENTION

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a representative basis for teaching one skilled in the art to employ the present invention.

As used in this specification and the appended claims, the singular forms “a”, “an” and “the” include plural referents unless the content clearly dictates otherwise. As used in this specification and the appended claims, the term “or” is generally employed in its sense including “and/or” unless the content clearly dictates otherwise.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom”, as well as derivatives thereof (e.g., “horizontally,” “downwardly,” “upwardly,” etc.), should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. All percentages are by weight unless otherwise indicated.

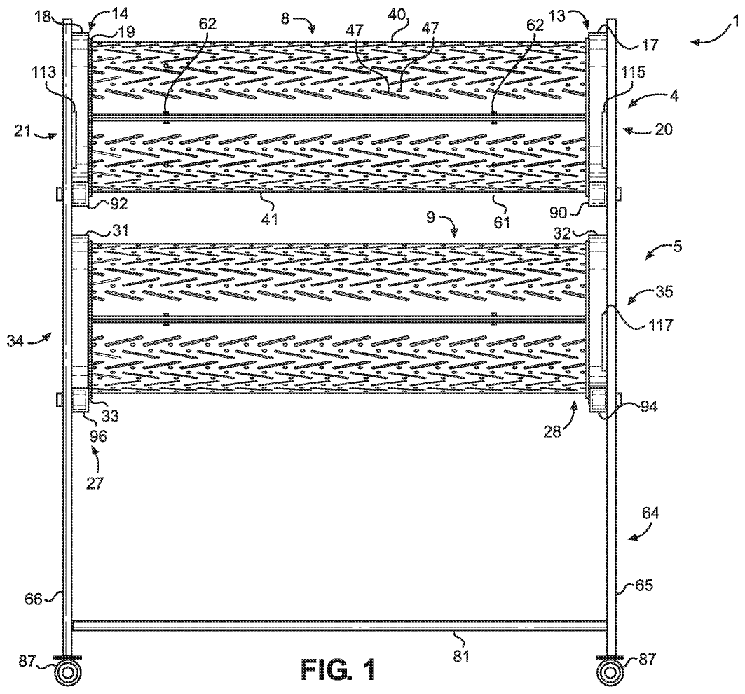

With initial reference to FIGS. 1-4, there is shown a separating apparatus 1 for processing solid material in accordance with the present invention. In general, separating apparatus can be used with a wide range of solid materials which can be readily broken apart, cut or otherwise trimmed, with the invention having particular use in separating agricultural materials, particularly plant material, like Cannabaceae. Separating apparatus 1 includes vertically spaced first and second rotatable barrels 4 and 5 which rotate within respective first and second saddles 8 and 9. More specifically, first rotatable barrel 4 includes a first main body 12 with first and second ends 13 and 14. First main body 12 has a circumferential surface 15 provided with a plurality of spaced openings 16. As shown, and is preferable, openings 16 take the form of slots. However, the spaced openings provided in the circumferential surface of the barrel are not limited to slots and the arrangement of the openings in the circumferential surface is not limited to the arrangement shown in the figures. The openings can be various sizes and shapes and can be arranged in the circumferential surface in varying configurations while still functioning in accordance with the invention as will become more fully evident below.

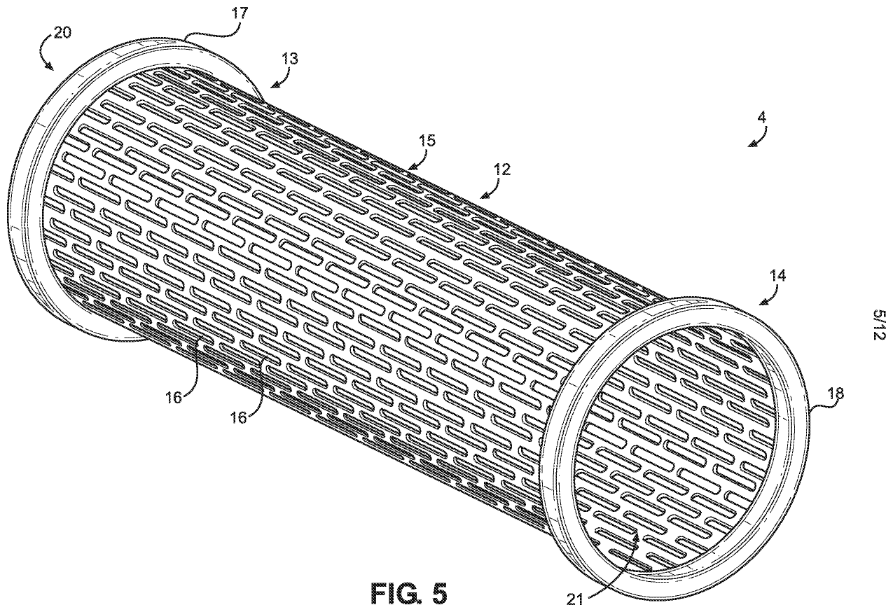

First end 13 of first main body 12 includes a first end rim 17 and second end 14 includes a second end rim 18. As shown, second end rim 18 is provided with a first rack gear 19 for engaging with a motor (described below). However, and alternately, first end rim 17 could have the first rack gear instead. Certainly, other drive arrangements could also be employed, including other gearing systems, a belt drive, or the like. First end 13 of the main body 12 further includes a first end opening 20 and second end 14 further includes a second end opening 21. Solid material (not shown in FIGS. 1-4) enters or exits first rotatable barrel 4 via end openings 20 and/or 21. Preferably, solid material enters first rotatable barrel 4 via first end opening 20 and exits first rotatable barrel 4 via second end opening 21. FIG. 5 shows a perspective view of first rotatable barrel 4 and its above-described features.

Vertically spaced from first rotatable barrel 4 is second rotatable barrel 5. Specifically, second rotatable barrel 5 is shown to be positioned below first rotatable barrel 4. Analogous to first rotatable barrel 4, second rotatable barrel 5 includes a second main body 26 with first and second ends 27 and 28. Second main body 26 has a circumferential surface 29 provided with a plurality of spaced openings 30. As shown, and is preferable, openings 30 take the form of slots. However, the spaced openings provided in the circumferential surface of the barrel are not limited to slots and the arrangement of the openings in the circumferential surface is not limited to the arrangement shown in the figures. First end 27 of second main body 26 includes a first end rim 31 and second end 28 includes a second end rim 32. As shown, first end rim 31 has a second rack gear 33 for engaging with a motor (described below). Again, other drive arrangements, located somewhere between first end rim 31 and second end rim 32 could be employed. First end 27 of second main body 26 further includes a first end opening 34 and second end 28 further includes a second end opening 35. Solid material (not shown in FIGS. 1-4) enters or exits second rotatable barrel 5 via end openings 34 and/or 35. In one embodiment of the invention, solid material enters second rotatable barrel 5 via first end opening 34 and exits second rotatable barrel 5 via second end opening 35. In another embodiment of the invention, solid material enters second rotatable barrel 5 via second end opening 35 and exits second rotatable barrel 5 via first end opening 34.

As mentioned above, after solid material is introduced into one of the barrels, the barrel is rotated, and the solid material is rotationally tumbled and axially propagated through the barrel (from one end of the barrel to another). As the solid material moves through the barrel, portions of the solid material may be separated by various means, such as collision, vibration, grating or cutting.

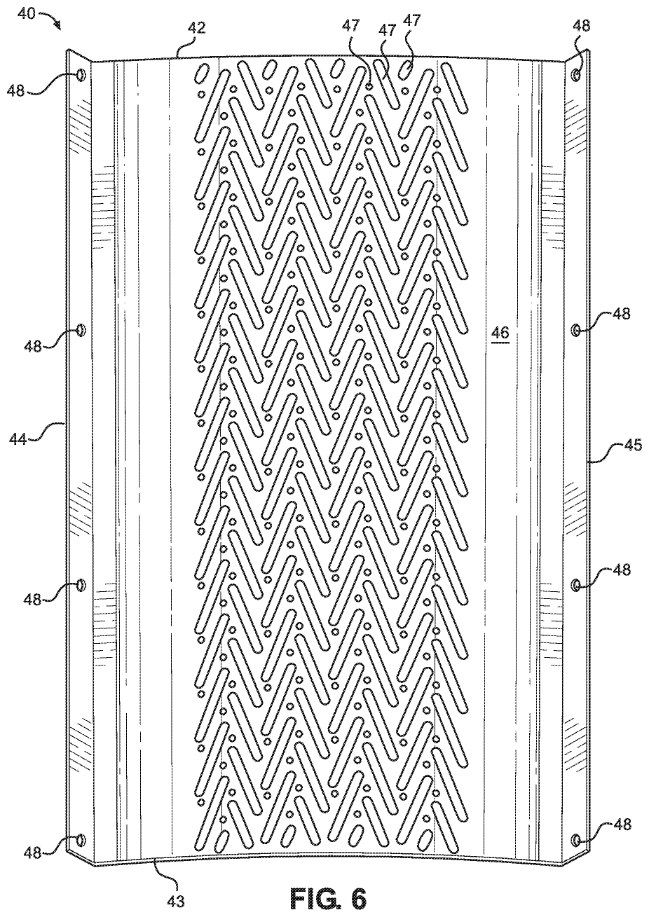

Separating can be accomplished when portions of the solid material protrude through the openings in the circumferential surfaces of the barrels (e.g., openings 16 or 30) as the solid material is rotationally tumbled through the barrels and interact with the saddles wrapped around the barrels, with the saddles essentially establishing cutting, knocking or otherwise trimming blades. As shown in FIGS. 1-4, first saddle 8 has a first section 40 and a second section 41. As best shown in FIG. 6, first section 40 has a first end 42, a second end 43, a first fastening edge 44 and a second fastening edge 45. First section 40 also has a surface 46 with a plurality of spaced openings 47. As shown and is preferable, the plurality of spaced openings in each of the saddles includes slots. Fastening edges 44 and 45 have a plurality of spaced fastening apertures 48. Similar to first section 40, second section 41 of first saddle 8 has a first end, a second end, a first fastening edge with fastening apertures, a second fastening edge with fastening apertures and a surface with a plurality of spaced openings but these are not separately labeled for second section 41 in the figures. Like first saddle 8, second saddle 9 has a first section and a second section, with each section having a first end, a second end, a first fastening edge with fastening apertures, a second fastening edge with fastening apertures and a surface with a plurality of spaced openings but these are not separately labeled for second saddle 9. Preferably, the saddles are made of an electro polished material and have anti-fouling surfaces. The openings in first rotatable barrel 4 and the openings in first saddle 8 overlap at one or more positions during rotation of barrel 4 within saddle 8. Similarly, the openings in second rotatable barrel 5 and the openings in second saddle 9 overlap at one or more positions during rotation of barrel 5 within saddle 9. Preferably, the slots of saddles 8 and 9 are angled relative to the slots of barrels 4 and 5, respectively, when saddles 8 and 9 are wrapped around barrels 4 and 5, respectively.

While saddles 8 and 9 are shown as having two sections each, a saddle of the present invention may have more sections or may only consist of a single section. Further, while first section 40 of first saddle 8 is shown to be placed adjacent an upper portion (not labeled) of the first rotatable barrel and second section 41 is shown to be placed on a lower portion (not labeled) of the first rotatable barrel, the one or more sections of a saddle of the present invention may be placed adjacent to a barrel in other arrangements.

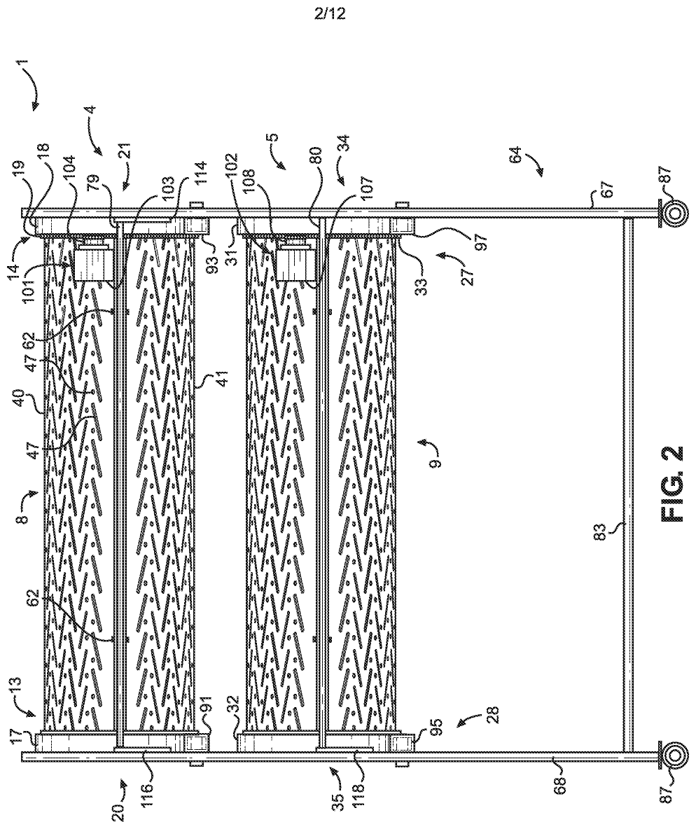

Preferably, saddles 8 and 9 are fixed relative to barrels 4 and 5, respectively, and act as fixed cutting blades. As shown in FIGS. 1-4, saddle 8 is fixed relative to barrel 4 using fasteners 62. In particular, fastening edges of saddle sections 40 and 41 are fastened together using fasteners 62 (fasteners 62 pass through the fastening apertures of the fastening edges of the saddle sections shown in FIG. 6). In FIGS. 2-4, the other fastening edges of saddle sections 40 and 41 overlap and are fastened together and to a support frame 64 of separating apparatus 1 using fasteners 62. Analogous to saddle 8, saddle 9 is fixed relative to barrel 5 and to support frame 64 using fasteners but these are not separately labeled. In preferred embodiments, saddles 8 and 9 are removable to facilitate cleaning, etc.

As further shown in FIGS. 1-4, separating apparatus 1 includes support frame 64 which includes a plurality of vertical bars 65-72 and a plurality of horizontal bars 75-84. Wheels 87 are fixed to the bottom of support frame 64 to allow the separating apparatus to be easily repositioned or relocated. Rollers 90-97 are rotatably mounted via stub-axles (not separately labeled) to horizontal bars 75-78 and support and vertically space rotatable barrels 4 and 5 of the separating apparatus. Specifically, rollers 90 and 91 are mounted to bar 75 and support first end 13 of first rotatable barrel 4 at first end rim 17, rollers 92 and 93 are mounted to bar 76 and support second end 14 of first rotatable barrel 4 at second end rim 18, rollers 96 and 97 are mounted to bar 78 and support first end 27 of second rotatable barrel 5 at first end rim 31 and rollers 94 and 95 are mounted to bar 77 and support second end 28 of second rotatable barrel 5 at second end rim 32. When saddles 8 and 9 are removed, barrels 4 and 5, respectively, are easily removable from upon rollers 90-97. While FIGS. 1-4 show a particular embodiment of a support frame for the separating apparatus of the present invention, other arrangements could be employed. What is important is that the support frame vertically spaces and rotatably supports the rotational barrels at least partially wrapped with their respective saddles.

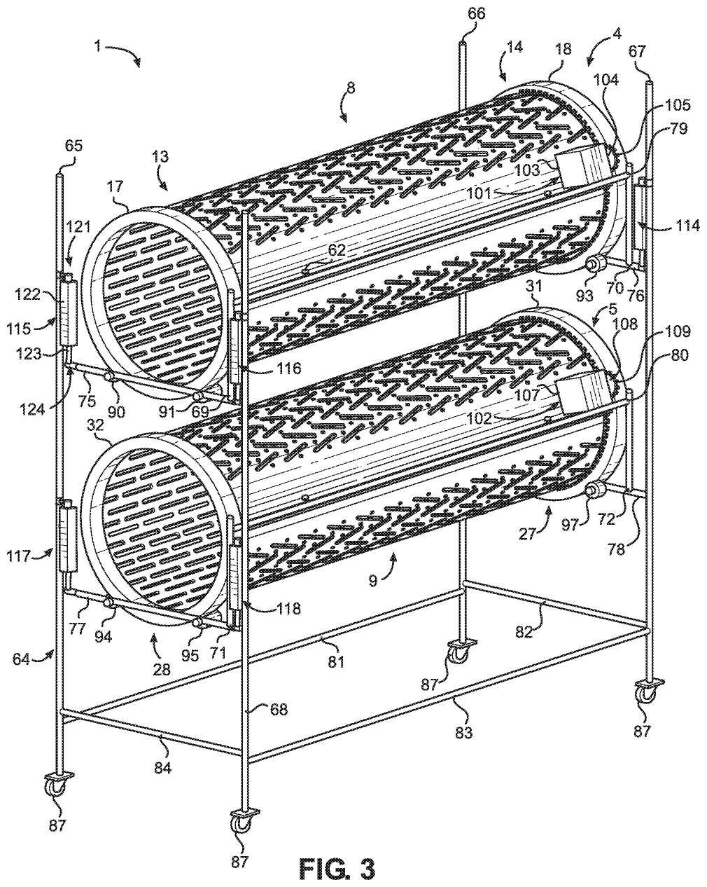

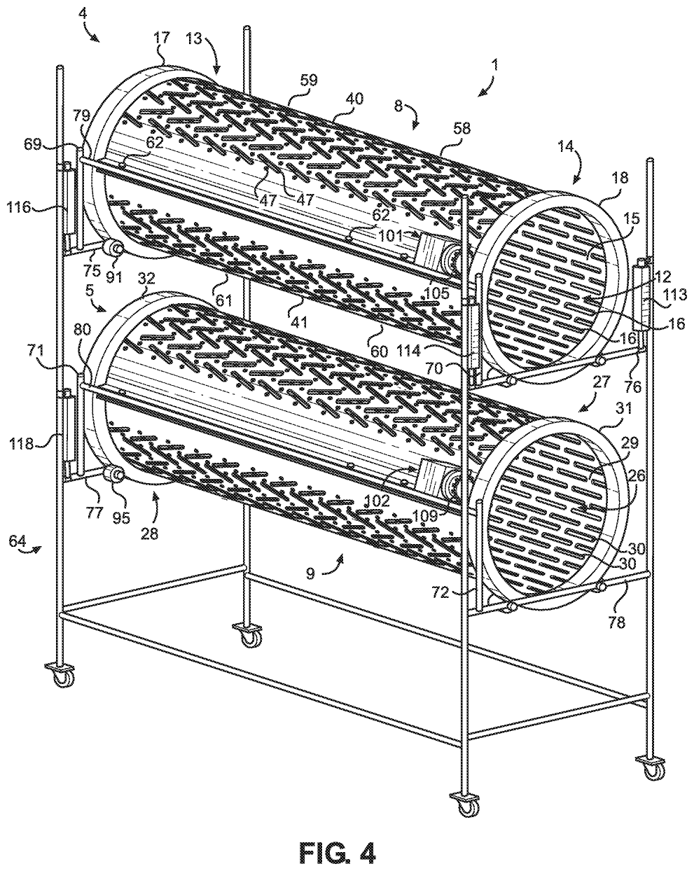

Separating apparatus 1 further includes a first motor 101 and a second motor 102 for driving the rotations of first rotatable barrel 4 and second rotatable barrel 5, respectively, relative to first saddle 8 and second saddle 9, respectively. As best seen in FIGS. 3 and 4, first motor 101 includes a first housing 103 from which a first output shaft 104 extends. First rotor 104 is terminated by a first pinion gear 105. Analogous to first motor 101, second motor 102 includes a second housing 107 from which a second output shaft 108 extends and is terminated by a second pinion gear 109. The pinion gears of the motors engage with the gears of the rotatable barrels (i.e., first and second rack gears 19 and 33). As the output shaft and pinion gear of each motor are caused to rotate, the teeth of the pinion gear engage and mesh with the teeth of the corresponding rack gear on the rotatable barrel to drive the rotation of the barrel. Preferably, the motors are energy efficient, low voltage motors such as DC brushless gear motors. Motors are not limited to the embodiment shown in FIGS. 1-4 and can include other drive assemblies which causes the rotation of one of the rotatable barrels.

As shown in FIGS. 2-4, first and second motors 101 and 102 are mounted onto horizontal bars 79 and 80, respectively, of support frame 64 and placed such that their pinion gears are engaged with the corresponding rack gears of the barrels. Horizontal bars 79 and 80 are supported by vertical bars 69-72 which extend from horizontal bars 75-78. As best shown in FIGS. 3 and 4, horizontal bars 75-77, which support first end 13 of first barrel 4, second end 14 of first barrel 4 and second end 28 of second barrel 5, respectively, via the rollers discussed above, are not directly attached to vertical bars 65-68 of the support frame. Rather, horizontal bars 75-77 are indirectly attached to vertical bars 65-68 via actuators 113-118, which comprise a longitudinal tilt mechanism of separating apparatus 1.

More specifically, a longitudinal tilt mechanism, which selectively lifts or lowers an end of a barrel so as to control the speed at which the solid material goes through the barrel, is included in some embodiments of the invention. Preferably, the longitudinal tilt mechanism includes one or more linear actuators 113-118. In an alternative embodiment not shown, actuators could be placed at first end 27 of barrel 5. Actuators 113-118 shown in FIGS. 1-4 are specifically telescoping linear actuators. Actuator 115 has a first end 121 attached to vertical bar 65, a housing 122, a telescoping arm 123 extending from and moving relative to housing 122 and a second end 124, at the terminus of the telescoping arm, attached to horizontal bar 75. Actuator 115 exemplifies the features common to all the shown actuators, but these are not labeled separately for each actuator. Actuator 115 works with actuator 116 to selectively lift or lower first end 13 of first rotatable barrel 4 relative to second end 14 of first rotatable barrel 4. Specifically, the telescoping arms of actuators 115 and 116 are moved into or out of housings 103 and 107, respectively, in order to raise or lower horizontal bar 75 to which first end 13 of the first barrel is rotatably supported. Similarly, actuators 117 and 118 work together to selectively lift or lower second end 28 of second rotatable barrel 5 relative to first end 27 of second rotatable barrel 5. Actuators 115 and 117 may work together to create a dual axis tilt platform. Or actuators 116 and 118 may work together to create a dual axis tilt platform. All of the actuators may also work together to raise and lower the barrels simultaneously. Rapid bi-directional control of the longitudinal tilt mechanism can establish vibration that causes portions of the solid material to be separated. Vibration can also be established through other mechanical arrangements known in the art.

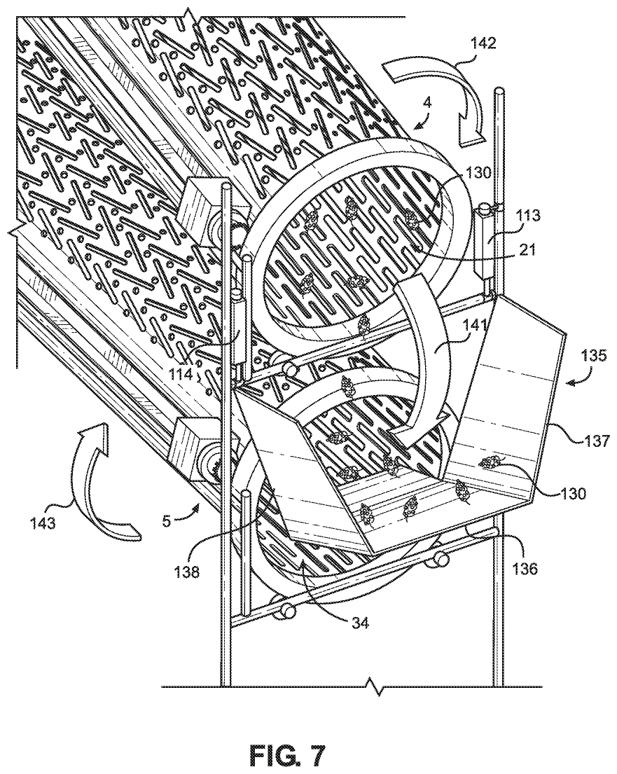

FIG. 7 illustrates an embodiment of the present invention in which solid material 130 is processed in first rotatable barrel 4 and then transferred to and further processed in second rotatable barrel 5 which is vertically spaced from first rotatable barrel 4. Solid material 130 can be transferred between barrels 4 and 5 by any suitable means. However, as shown in FIG. 7, transfer of solid material 130 is accomplished with the use of gravity and airflow along with a transfer unit 135. Transfer unit 135 includes a main panel 136 and two side panels 137 and 138, which are folded inwardly relative to the main panel. As solid material 130 exits first rotatable barrel 4 via second end opening 21, solid material 130 falls under the influence of gravity in the direction of arrow 141 and upon panels 136, 137 and/or 138 of transfer unit 135. Panels 136-138 of transfer unit 135 are angled towards first end opening 34 of second rotatable barrel 5 such that solid material 130 is guided towards and enters second rotatable barrel 5 at first end opening 34.

Arrows 142 and 143 represent the direction in which first and second barrels 4 and 5 respectively rotate. In the embodiment shown in FIG. 7, arrows 142 and 143 indicate that first and second barrels 4 and 5 are rotating in the same direction. However, in other embodiments, first and second barrels 4 and 5 are rotating in different directions.

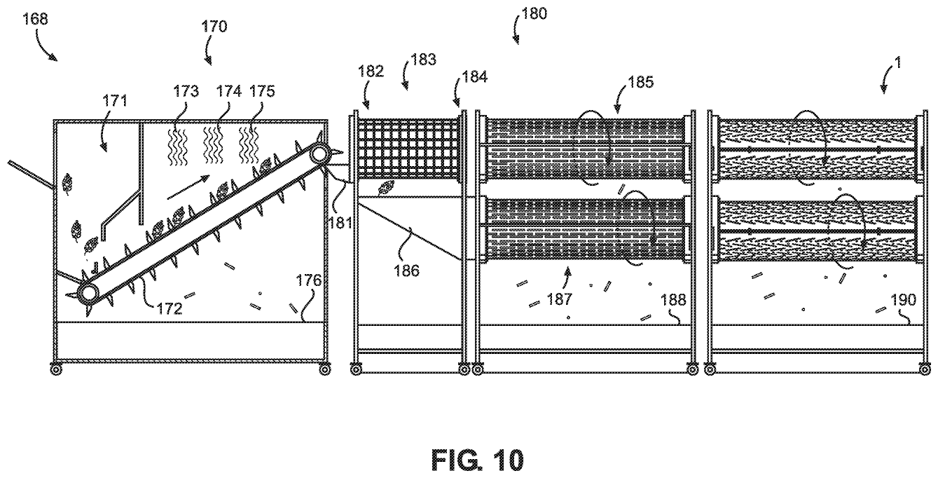

In another embodiment of the present invention, solid material is processed simultaneously in the two or more vertically spaced barrels. This is discussed further below in relation to FIG. 10.

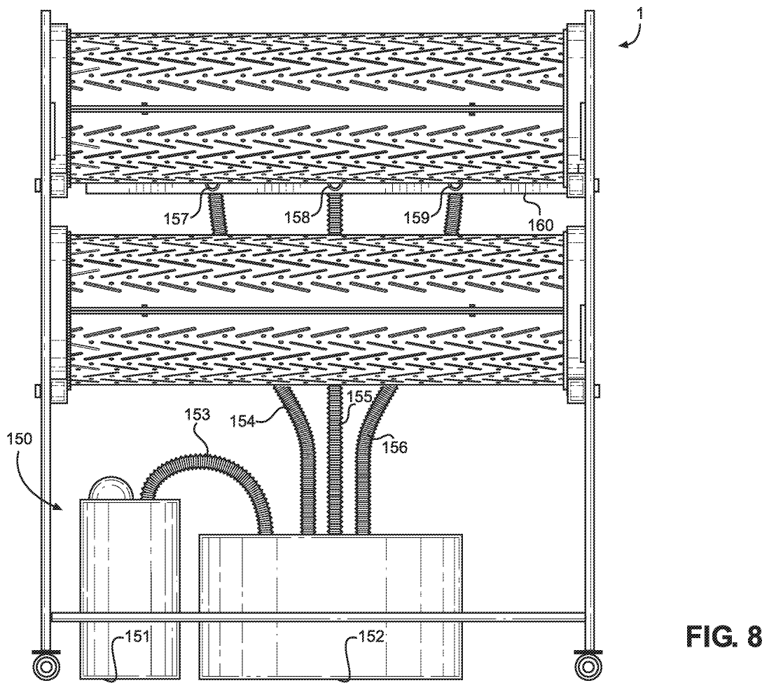

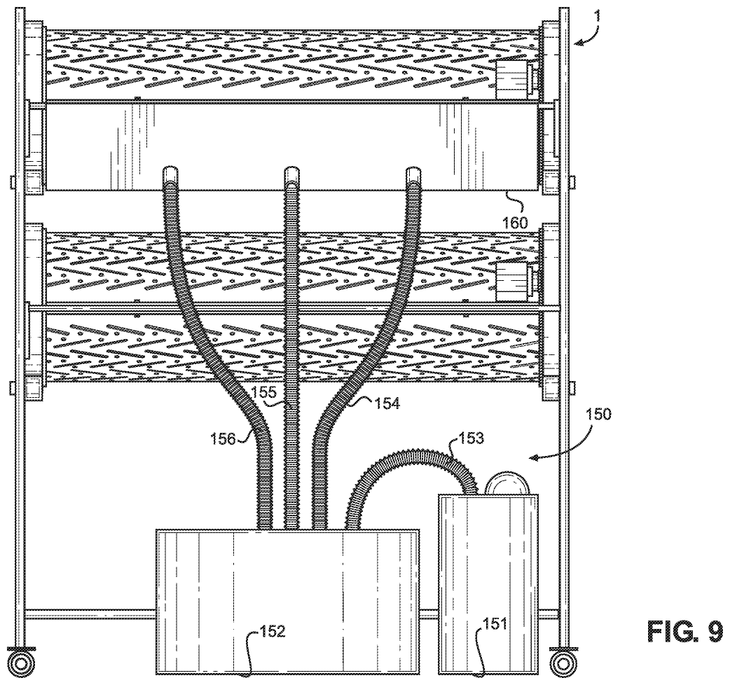

In an embodiment of the present invention, as portions of the solid material are separated therefrom as the solid materials traverses rotary barrels 4 or 5, the separated portions (e.g., trimmings) can be collected using a vacuum system 150. FIGS. 8 and 9 show vacuum system 150 used with separating apparatus 1. Vacuum system 150 includes a vacuum device 151 connected to a collection bin 152 via a hose 153. Each hose 154-156 has one of its ends connected to collection bin 152. The other ends of hoses 154-156 form ports 157-159, respectively, which are mounted in a port support 160 carried by support frame 64 of separating apparatus 1. Vacuum device 151 reduces the pressure inside collection bin 152 (relative to the pressure outside collection bin 152) to create suction at each of ports 157-160, which are mounted adjacent to the lower portion of first rotatable barrel 4. The suction created by vacuum system 150 causes separated portions of the solid material to be drawn through openings 47 in first saddle 8 (and possibly through openings 16 in first barrel 4) and into collection bin 152 via ports 157-159. In other embodiments of the invention, vacuum system 150 is instead placed adjacent second rotary barrel 9, or both rotary barrels 4 and 5 have vacuum-assisted collection. Further, the vacuum system may have more or fewer ports and hoses than shown in FIGS. 8 and 9 or a different configuration than shown in FIGS. 8 and 9. Vacuum system 150 may also assist in causing portions of the solid material to protrude through openings in barrel 4 and interact with the saddle 8.

As an alternative to, or in addition to, a vacuum system, a collection bin (separate from collection bin 152) may be placed below one or more of the rotary barrels to collect separated portions that fall through the openings in the barrels and saddles under the influence of gravity.

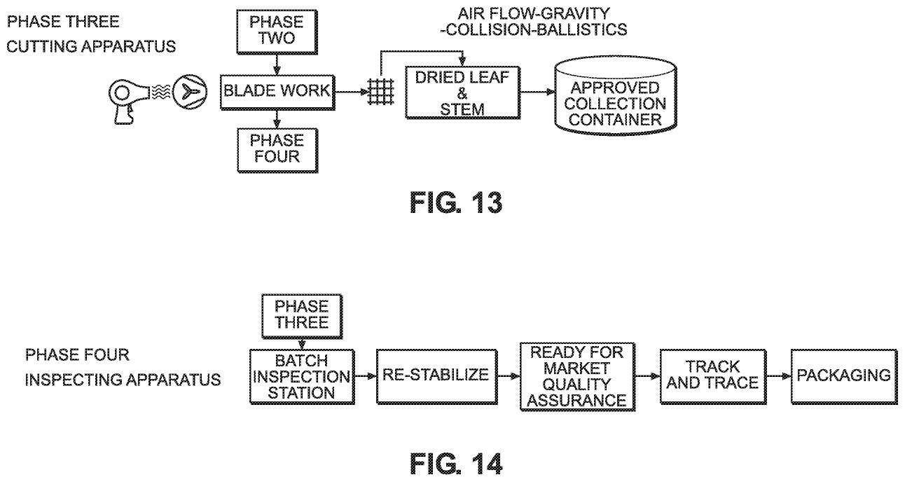

The separating apparatus of the present invention may include additional features such as airflow control systems and/or environmental control systems, as discussed further below at least in relation to FIG. 13.

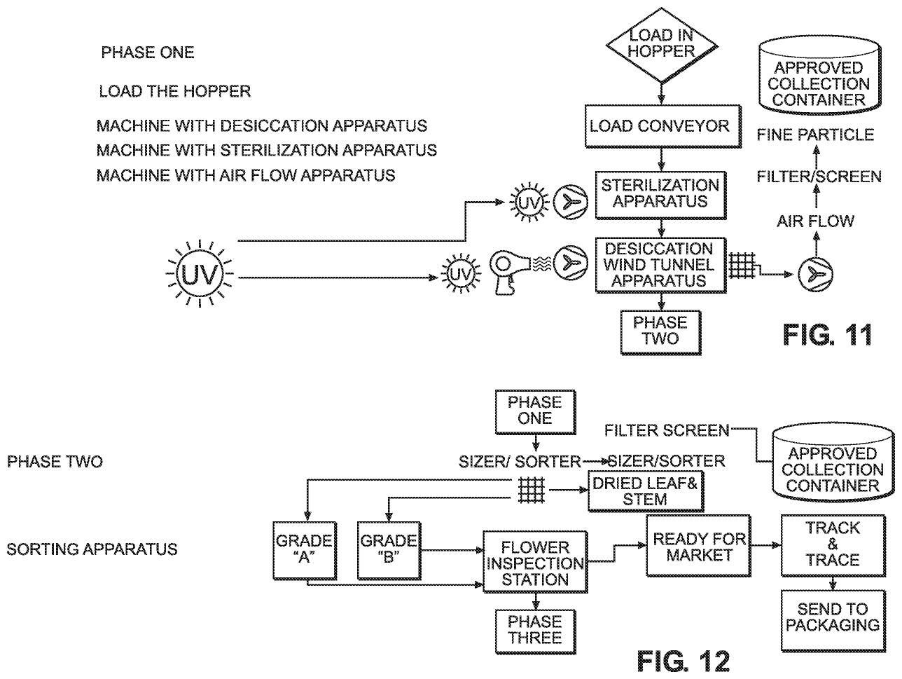

FIGS. 10-14 show how separating apparatus 1 may be used in combination with other processing equipment and techniques. Initially, with reference to FIGS. 10 and 11, a solid material in a solid material processing system 168 is dried and sterilized in a drying machine 170 of the system in a Phase One. The solid material (not labeled) is loaded into a hopper 171 which then discharges and spreads the solid material in a single layer upon a perforated conveyor belt 172. Although a conveyor belt is specifically shown, other arrangements could be employed such as a conveyor tube, a cable system conveyor or a vacuum conveyor. What is important is that the solid material is conveyed from hopper 171. A flow of controlled dry air and/or other gas 173 is blown upon and past the solid material as the solid material is transported on conveyor belt 172 in order to dehydrate/desiccate the solid material. Used air and/or other gas 173 may be collected, regenerated into dry air and/or gas and recycled back into drying machine 170. Dry air and/or gas 173 may be regenerated by any of a variety of processes including using a dehumidifier, a dryer, a blower, a heater, a cooler or an infrared lamp. In addition to dry air and/or other gas 173, the solid material is treated with UV light 174 and hydroxyl radicals 175 as the solid material is transported on conveyor belt 172 in order to sterilize the solid material (i.e., kill any surface biological contaminants on the solid material). A bin 176 is placed beneath conveyor belt 172 to collect portions of solid material that may separate and fall from the solid material as it is transported. As the solid material leaves drying machine 170, a sensor (e.g., a camera, an x-ray sensor, etc., not shown) identifies any undesirables (e.g., foreign objects, discolored materials, mold, etc.) to be removed. Solid material in need of further processing after leaving drying machine 170 is transferred to a sorting machine 180 and begins a Phase Two.

Referring to FIGS. 10 and 12, solid material from drying machine 170 is introduced via a trough 181 into a first end 182 of a sorting barrel 183. The solid material is graded by size as it progresses through sorting barrel 183 which has a circumferential surface with a plurality of openings. Solid material which is not small enough to fit through the openings (e.g., “Grade A”) exits sorting barrel 183 at a second end 184 of sorting barrel 183 into a first separator barrel 185. Solid material which is small enough to pass through the openings of sorting barrel 183 (e.g., “Grade B”) drops out of sorting barrel 183 into a catch trough 186 which funnels the solid material into a second separator barrel 187. In separator barrels 185 and 187 the sorted solid material is rotationally tumbled such that loose material is separated from the material (e.g., by agitation, vibration, etc.) and falls from openings in separator barrels 185 and 187 and into a bin 188 below separator barrels 185 and 187. Solid material in need of further processing after leaving sorting machine 180 is transferred to a separating apparatus 1 and begins a Phase Three.

Separating apparatus 1 has the features and functions described above in relation to FIGS. 1-4, with the exception of the addition of a bin 190 below rotary barrels 4 and 5 for collecting the separated portions of the solid material. Instead of solid material being transferred from first rotary barrel 4 to second rotary barrel 5 as shown in FIG. 5, solid material in FIG. 10 is processed in first and second rotary barrels 4 and 5 simultaneously. Specifically, solid material exiting first separator barrel 185 of sorting machine 180 is introduced into and processed by first rotary barrel 4 of separating apparatus 1 at the same time that solid material exiting second separator barrel 187 of sorting machine 180 is introduced into and processed by second rotary barrel 5 of separating apparatus 1. In Phase Three, referring to FIGS. 10 and 13, the solid material undergoes blade work in separating apparatus 1 within an environment having temperature- and humidity-controlled, sterilized air.

Finally, in Phase Four, in reference to FIG. 14, processed solid material is inspected by machines or human workers to determine if the product is ready for packaging. If the product is ready for packaging, the product is stabilized (e.g., by the addition of nitrogen), packaged and inspected for marketability.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respects, only illustrative. Changes may be made in details, particularly in matters of shape, size, and arrangement of parts without exceeding the scope of the disclosure. The disclosure's scope is, of course, defined in the language in which the appended claims are expressed.

1. An apparatus for separating solid material, the apparatus comprising:
a first rotatable barrel including a first main body with first and second ends, said first main body having a circumferential surface provided with a plurality of spaced openings;
a second rotatable barrel including a second main body with first and second ends, said second main body having a circumferential surface provided with a plurality of spaced openings, wherein said second rotatable barrel is rotatably supported in a position vertically spaced from the first rotatable barrel;
a first saddle having a plurality of openings, said first saddle being wrapped at least partially around and fixed relative to the circumferential surface of the first rotatable barrel;
a second saddle having a plurality of openings, said second saddle being wrapped at least partially around and fixed relative to the circumferential surface of the second rotatable barrel; and
a transfer unit, wherein:
the first rotatable barrel is configured to receive the solid material at the first end of the first main body and to cooperate with the first saddle to separate portions of the solid material as the solid material moves from the first end of the first main body to the second end of the first main body to exit the first rotatable barrel as the first rotatable barrel is rotated relative to the first saddle,
the transfer unit is configured to receive the solid material exiting the first rotatable barrel at the second end of the first main body and to transfer the solid material to the first end of the second main body, and
the second rotatable barrel is configured to cooperate with the second saddle to separate additional portions of the solid material as the solid material moves from the first end of the second main body to the second end of the second main body to exit the second rotatable barrel as the second rotatable barrel is rotated relative to the second saddle.

2. The apparatus of claim 1, further comprising a support frame including roller assemblies, wherein the first and second saddles are secured to the support frame so as to be stationary during rotation of the first and second rotatable barrels and the roller assemblies are configured to rotatably support the first and second rotatable barrels for rotation relative to the first and second saddles.

3. The apparatus of claim 2, wherein the roller assemblies include a first set of rollers that supports the first end of the first main body, a second set of rollers that supports the second end of the first main body, a third set of rollers that supports the first end of the second main body and a fourth set of rollers that supports the second end of the second main body.

4. The apparatus of claim 1, further comprising a first motor and a second motor, the first motor being configured to engage with the first rotatable barrel and drive the first rotatable barrel to rotate relative to the first saddle and the second motor being configured to engage with the second rotatable barrel and drive the second rotatable barrel to rotate relative to the second saddle.

5. The apparatus of claim 4, wherein the first rotatable barrel further includes a first rack gear and the first motor includes a first pinion gear, the second rotatable barrel further includes a second rack gear and the second motor includes a second pinion gear, the first pinion gear being configured to engage the first rack gear to drive the first rotatable barrel to rotate relative to the first saddle and the second pinion gear being configured to engage the second rack gear to drive the second rotatable barrel to rotate relative to the second saddle.

6. The apparatus of claim 1, further comprising a longitudinal tilt mechanism configured to selectively lift or lower the first end of the first main body relative to the second end of the first main body.

7. The apparatus of claim 6, wherein the longitudinal tilt mechanism includes a telescoping linear actuator.

8. The apparatus of claim 1, wherein each of the rotatable barrels has, between the first and second ends of the main bodies, an upper portion and a lower portion, and wherein the saddles are wrapped entirely around at least the lower portions of their respective rotatable barrels.

9. The apparatus of claim 1, wherein the plurality of spaced openings in each of the saddles and in each of the main bodies includes slots, the slots in the first saddle being angled relative to the slots in the first main body and the slots in the second saddle being angled relative to the slots in the second main body.

10. A method for separating solid material with
a separating apparatus having a first rotatable barrel including a first main body with first and second ends, said first main body having a circumferential surface provided with a plurality of spaced openings; a second rotatable barrel including a second main body with first and second ends, said second main body having a circumferential surface provided with a plurality of spaced openings, wherein said second rotatable barrel is rotatably supported in a position vertically spaced from the first rotatable barrel; a first saddle having a plurality of openings, said first saddle being wrapped at least partially around and fixed relative to the circumferential surface of the first rotatable barrel; a second saddle having a plurality of openings, said second saddle being wrapped at least partially around and fixed relative to the circumferential surface of the second rotatable barrel; and a transfer unit, said method comprising:
introducing the solid material into the first end of the first main body;
rotating the first rotatable barrel relative to the first saddle to cause the solid material to move from the first end of the first main body to the second end of the first main body and to separate portions of the solid material as the solid material moves from the first end of the first main body to the second end of the first main body;
transferring the solid material from the second end of the first main body to the first end of the second main body with the transfer unit; and
rotating the second rotatable barrel relative to the second saddle to cause the solid material to move from the first end of the second main body to the second end of the second main body and to separate additional portions of the solid material as the solid material moves from the first end of the second main body to the second end of the second main body.

11. The method of claim 10, wherein rotating the first rotatable barrel includes engaging a first motor with the first rotatable barrel and rotating the second rotatable barrel includes engaging a second motor with the second rotatable barrel.

12. The method of claim 11, wherein engaging a first motor with the first rotatable barrel includes engaging a first pinion gear of the first motor with a first rack gear of the first rotatable barrel and engaging a second motor with the second rotatable barrel includes engaging a second pinion gear of the second motor with a second rack gear of the second rotatable barrel.

13. The method of claim 10, wherein rotating the barrels includes rotating the first and second rotatable barrels in the same direction.

14. The method of claim 10, further comprising selectively lifting or lowering the first end of the first main body relative to the second end of the first main body.

15. The method of claim 14, wherein selectively lifting or lowering the first end of the first main body relative to the second end of the first main body includes telescoping at least two parts of a linear actuator.

16. The method of claim 10, further comprising collecting the separated portions or the separated additional portions.
